(19) United States
(12) Patent Application Publication
(10) Pub. No.: US 2018/0129198 A1
(43) Pub. Date: May 10, 2018

(54) REMOTE CONTROLLED SAFETY BABY WALKER

(71) Applicant: Michael Gronwald, South Weber, UT (US)

(72) Inventor: Michael Gronwald, South Weber, UT (US)

(21) Appl. No.: 15/350,151

(22) Filed: Nov. 14, 2016

Related U.S. Application Data
(60) Provisional application No. 62/418,205, filed on Nov. 6, 2016.

(51) Int. Cl. G05D 1/00; A47D 13/04; G05B 19/409; G05D 1/02

(52) U.S. Cl. CPC G05D 1/0011; A47D 13/04; G05B 2219/36169; G05D 1/0214; G05B 2219/40244; G05B 19/409

(57) ABSTRACT

The inventive aspect described in the specification can be embodied in a method for remotely monitoring and controlling the movements of a baby walker. The further inventive aspects can be embodied in a method wherein controlling movement of the baby walker includes restricting the movement of the baby walker within an area. The other inventive aspects can be embodied in a method for remotely controlling movements of a baby walker wherein controlling includes remotely controlling the baby walker via a smart device. Yet other inventive aspects may include sensing an elevation of the baby walker relative to a surrounding area.

### FIELD

This application claims priority to U.S. Provisional Patent Application No. 62/418,205 filed on Nov. 6, 2016, which is incorporated herein in its entirety by reference.

Example embodiments described herein generally relate to remotely controlling and monitoring a baby walker

### BACKGROUND

Parents and other adults use baby walkers to allow a child to move about while still being able to be monitored, Walkers generally have a sufficient frame, to support the child and include wheels, so the child may travel over level ground. The walkers are designed to protect the child from falls, yet allow a significant degree of mobility. The walker apparatus enables the child to gain walking skills and strength and also may include other training, education, and/or amusement devices. However, the walker must be kept in constant view and also the child may still wander into a dangerous object or a dangerous area, such as a stairwell.

U.S. Pat. No. 6,983,813 to Wright, discusses a baby walker with motor-drives wheels. The wheels are connected to sensors and also to a remote control system. The sensors are designed to prevent the walker from colliding with objects, such as furniture. Furthermore, the adult can control the baby walker using remote control.

U.S. Pat. No. 9,107,513 to Asia, discusses a baby walker with a breaking mechanism. A sensor unit is configured to sense an obstacle in fee way of the walker and activate the braking system. The system includes a wave transmitter to generate signals on sensing an obstacle. The braking system may also be controlled remotely by a parent or adult.

### SUMMARY

The present disclosure provides an improved smart baby walker that can be monitored remotely with a mobile device, such as a smart phone, IPAD, or other like devices. As such, the general purpose of the present disclosure, which will be described subsequently in greater detail is to provide a new and improved remotely controlled baby walker.

The inventive aspect described in the specification can be embodied in a method for remotely monitoring and/or controlling the movements of a baby walker. The method may include sensing an elevation of the baby walker relative to a surrounding area. Then, based on the sensed elevation of the area, the baby walker can be controlled both in automatic and manual ways. The further inventive aspects can be embodied in a method wherein controlling movement of the baby walker includes restricting the movement of the baby walker within a designated area. Thus, a parent or adult may control the area the baby can move for safety or ease of monitoring.

The other inventive aspects can be embodied in a method for remotely monitoring the movements of baby walker. The method may further include sensing the position, speed, and acceleration of the baby walker, and surface characteristics of an area around the baby walker. The movement of the baby walker is then controlled based on at least one of a sensed position, speed, acceleration, md surface characteristics.

Thus, one or combination of the position, speed, acceleration, and surface characteristics may be used to estimate if a baby walker needs to be controlled or if a notification should be sent to a parent or adult. Thus, the sensor and control system may respond automatically to one or a combination of a dangerous or forbidden sensed parameters including the movement and position characteristics of the baby walker relative to its surroundings. Further, a notification may be sent to a parent or adult to let them know of one or a combination of a dangerous or forbidden sensed parameter. The parent or adult may then choose to control the baby walker is a particular way remotely. This may be done using a mobile device and/or internet application.

The method may further comprise sensing at least one position, speed, acceleration. and surface characteristics of the baby walker in an area around the baby walker. Thus, one or more surfaces including other objects or a movement surface (floor) may be monitored using sensors for safety characteristics. Thus, based on the sensed characteristics of the surrounding area and based on at least one of sensed position, speed, acceleration, the movement of the baby walker may be controlled. The control may include a command for a movement, such as to move to a determined area or may include a command to stop the baby walker. This control may be performed remotely using a smart phone, other mobile application, and/or an internet based application.

Yet other inventive aspects can be embodied in a system for controlling the baby walker further including comparing at least one of sensed position, speed, acceleration, or surface characteristics of the baby walker with a threshold value when controlling the movement of the baby walker. Thus, if one or more sensed characteristics exceeds a threshold value that has been previously determined or determined by a remote user who may have received a notification based on the sensed characteristic, and then it is determined that the sensed values have exceeded the threshold values. The method may further include wherein the position is determined using a GPS attached to the baby walker. Thus, the position and movement characteristics can be known and utilized for one or more threshold determinations in real time.

The other inventive aspects can be embodied in a method wherein controlling includes remotely controlling the baby walker via a smart device. Thus, one or more smart devices may control the movement characteristics of one or more baby walkers. The one or more smart devices may include such devices as a smart phone, IPAD, and other like devices. The baby walker may also be controlled by accessing, the internet using a smart device, or an internet application. Further, the method may include wherein controlling includes stopping the movement of the baby walker when the baby walker is outside a boundary. Thus, based on the positon and/or sensed characteristics, a position may be determined and compared with a forbidden boundary or zone. Thus, if the baby walker had entered a forbidden zone it may be stopped immediately or directed to an acceptable location. This may be done automatically or remotely by at least one user. Further, the method may include wherein controlling includes sending a warning signal to a smart device before the baby walker crosses a desired boundary. Thus, at least one of user, such as a parent or adult, may implement a control command based on the warning signal.

In another example embodiment, the system for controlling the baby walker includes the remote device wherein the remote device generates a visual guide by using the sensed data wherein the visual guide is displayed on a touch sensitive interface to allow a user to use the visual guide to generate the control signal to control the baby walker.

In this respect, before explaining at least one embodiment of the disclosure in detail, it is to be understood that the disclosure is not limited in its application to the details of the construction and to the arrangements of the components set forth in the following description or illustrated in the drawings. The disclosure is capable of other embodiments and of being practiced and carried out in various ways. Also, it is to be understood that the phraseology and terminology employed herein are for the purpose of description and should not be regarded as limiting.

These together with other objects of the disclosure, along with the various features of novelty which characterize the disclosure, are pointed out with particularity in the disclosure. For a better understanding of the disclosure, its operating advantages and the specific objects attained by its uses, reference should be made to the accompanying drawings and descriptive matter in which there are illustrated preferred embodiments of the disclosure.

### BRIEF DESCRIPTION OF THE DRAWINGS

FIG. 1 shows a system for tracking movement and position of a baby walker, according to an example embodiment.

FIG. 2 shows a baby walker system including sensors having remote connectivity, according to an example embodiment.

FIG. 3 shows a system for onboard computing, data receiving, decision making, and communication according to an example embodiment.

FIG. 4 shows mobile interface for a baby walker according to an example embodiment.

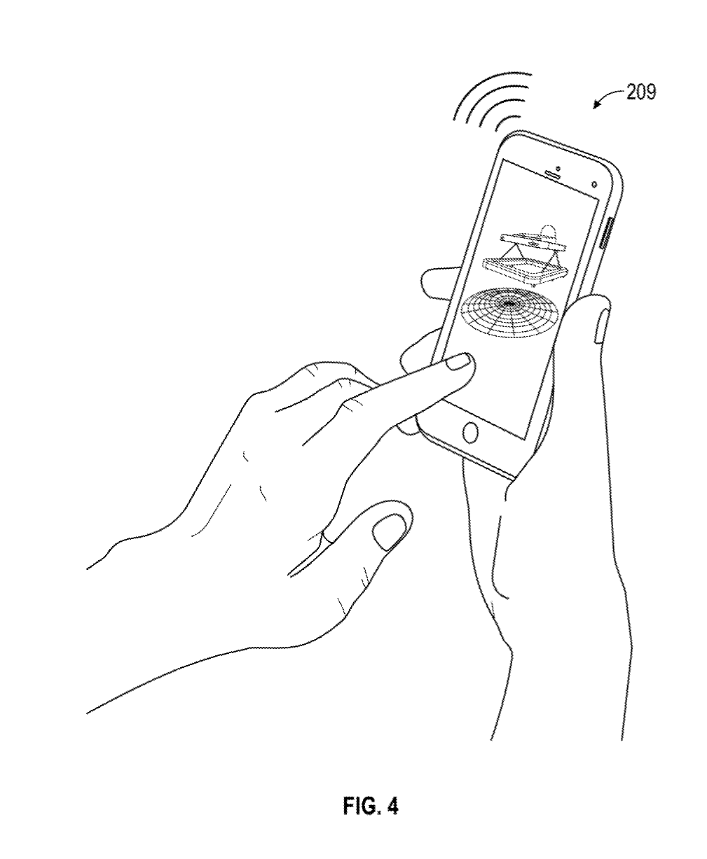

FIG. 5 shows baby walker system and mobile application to control baby walker according to an example embodiment.

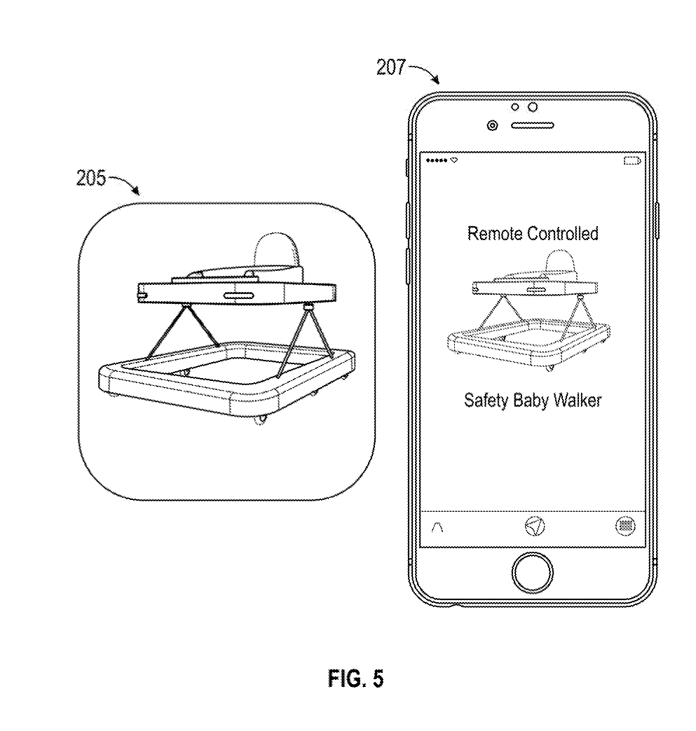

### DETAILED DESCRIPTION

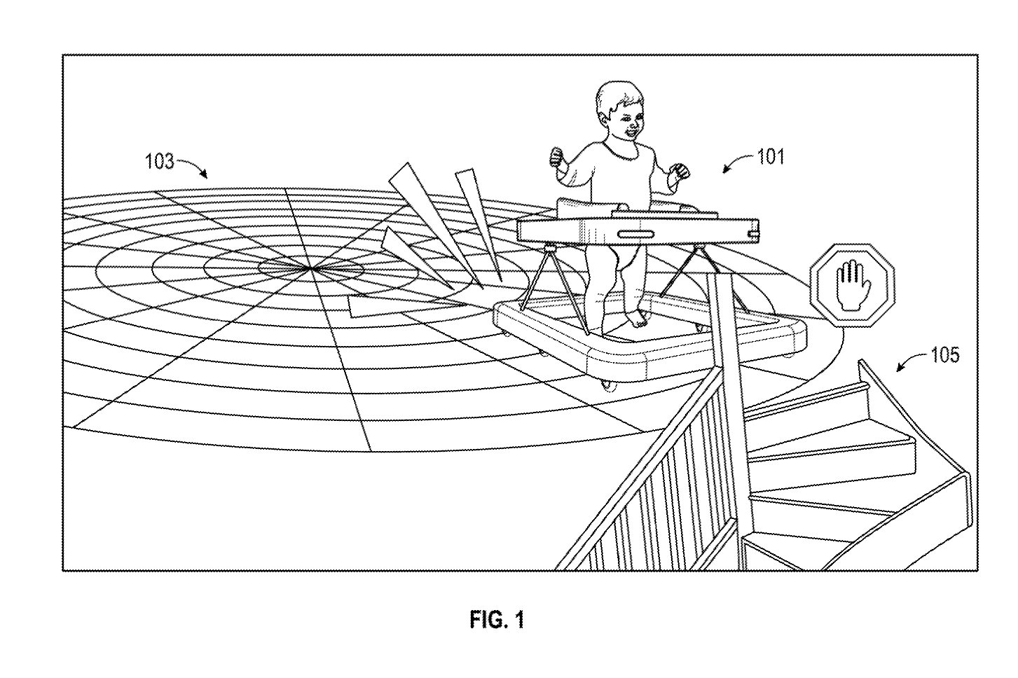

FIGS. 1-3 show a system for tracking movement and position for a baby walker, according to an example embodiment. At least one movement and/or position sensor may be positioned at the bottom of the walker (101). The movement sensor detects position, speed, surface characteristics or proximity data and transmits one or more of these detected data and characteristics to a smart phone, a mobile device, or an internet based application. In one example embodiment, the at least one sensor may determine a location of the baby walker (101) and determine whether the baby walker is within an acceptable zone (103), is projected to enter a forbidden zone, or has entered a forbidden zone (105). Further, the one or more characteristics from the sensor data may be integrated according to one or more algorithms before sending or upon receiving. In one embodiment, an application on the smart phone analyzes the data received and controls the walker based on the received data. Such control may be based on a change in movement data, surface characteristic data, or a combination thereof received from the sensor.

In one embodiment, a user nun program the baby walker using a smart phone app or internet based application to stay inside an area determined by the user. The at least one user may update one or more times the allowed zone by initiating a manual input on the mobile app. In one embodiment, the at least one walker may encounter the boundary of the allowed zone, which at least in part initiates the braking system to turn the walker. In one embodiment, the walker may be stopped entirely at the boundary of the allowed zone. In one embodiment, the braking and/or navigation system may be activated to avoid one or more objects within the allowed zone.

In one embodiment, at least one sensor determines an elevation based on a distance determination with the floor surface or ground. In one embodiment, there may be a change in elevation that is more than a configured deviation limit set-up in the sensor (e.g. approaching a staircase (105) or very near). The walker may also anticipate that a sudden change in elevation may take place if the walker follows a current path. The sensor sends a signal to the connected brake of the baby walker to stop.

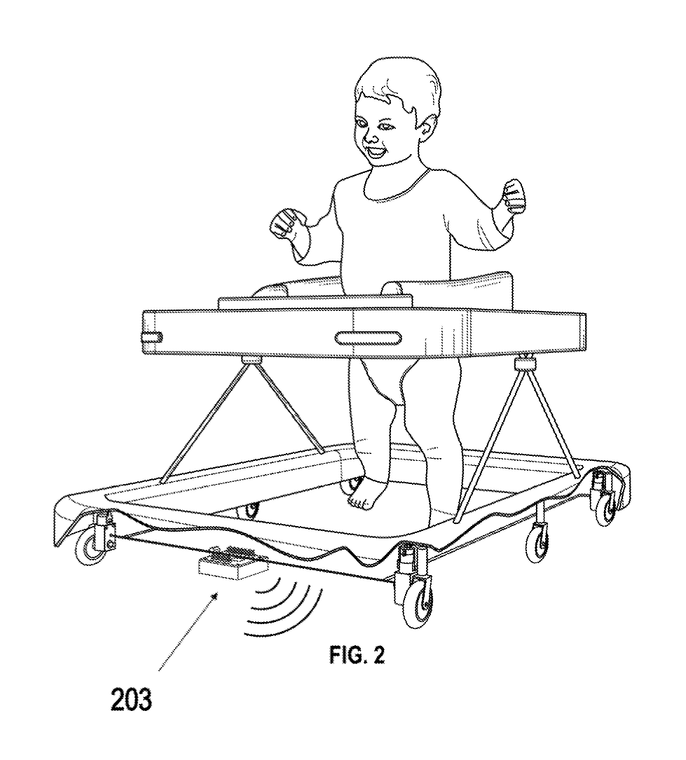

FIG. 2 shows a system for a sensor having remote connectivity, according to an example embodiment. In one embodiment, a system, such as a baby walker (101), may include at least one sensor (203) having GPS connectivity. In one embodiment, a control mechanism is provided to restrict the movement of the walker based on its location (205). In another embodiment, a smart phone application (207) provides an ability to locate a position of the walker using a GPS capability in conjunction with a sensor. In one embodiment, a set-up mechanism may be used as part of the phone application to set the limit of movement of the walker based, on its location. This limit of movement location zone provides a boundary limit for the walker. Further, a user may control the boundary settings and/or response to at least one notification with a manual input (209).

In one embodiment, as the walker moves, out of a predefined boundary, the system triggers at least one signal based on surface characteristic data that is received by at least one sensor. The signal may subsequently trigger a control mechanism to activate at least one function of the walker, such as the braking system to stop the movement of the walker. In one embodiment, the at least one sensor is coupled to the brakes of the walker, which are activated by the at least one signal based on surface characteristic data that is received by at least one sensor.

In one embodiment, the baby walker movement may be restricted within a predefined boundary. When the walker moves out of the boundary, system triggers at least one signal to alarm, the user via mobile device.

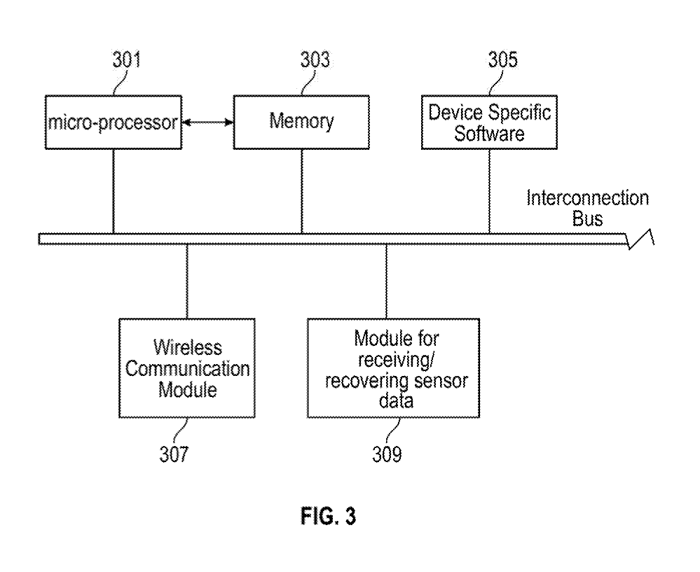

FIG. 3 shows a system for onboard computing, data recovering, sensing, and communication, according to an example embodiment. In one embodiment, a small onboard computer system may be attached under the walker. In one example embodiment, the computer system may include a processor (301), memory (303), and device specific software (305). Further, the system may include a wireless communication module (307) and a sensor data module (309). Each of the modules may communicate with one another. In one embodiment, the sensor data module (309) may provide information to one or more of the other modules including the device specific software (305), processor (301), and memory (303), which in turn may communicate with the wireless communication module (307) to send a signal to at least one mobile device and/or internet based application. The components of the computer system may be integrated or work separately. The computer system may be connected to the at least one brake and/or at least one sensor.

In one embodiment incoming information, such as from a smart phone control signal, may be received by the computer system from at least one of a GPS system, phone app, and/or sensors. Such incoming information may at least partially engage one or more brakes when necessary. In addition, the baby walker computer, sensors, GPS system, and control equipment may be powered using a rechargeable battery unit.

In one embodiment, the baby walker may include a system for controlling that includes comparing a sensed characteristic with a threshold value. In one embodiment, one or more parameters including at least one of a sensed position, speed, acceleration, or surface characteristics of the baby walker may be compared with a threshold value when controlling the movement of the baby walker. Thus, the one or more sensed characteristics may exceed a threshold value that has been previously determined or determined by a remote user who may have received a notification based on the sensed characteristic and then provides a determination of whether the sensed characteristic exceeds a threshold value. In one embodiment the method may include wherein the position and movement characteristics are determined using a GPS attached to the baby walker. Thus, the position and movement characteristics can be known and utilized for one or more threshold determinations in real time.

In one embodiment, the movements of the baby walker are controlled using a smart phone application. Thus, the movements of the walker can be tracked from the smartphone application via a GPS function that, is integrated with the sensor system of the walker. In one embodiment, the application can be downloaded to a smart phone and can include multiple control and monitoring functions. The application may also be updatable with new and improved functions as required or deemed appropriate. In one embodiment, a user may monitor more than one baby walker using a mobile app and/or internet based application. Thus, multiple children may be observed by a parent or adult, which reduces the difficulty of trying to track and monitor multiple children simultaneously.

In one embodiment, at least one user may observe, via a smart phone application, a situation in which the walker is required to change direction or stop entirely. This change or stoppage of movement of the walker may be activated using at least one manual input for the smart phone application. The at least one user may press at least one control button on a smart phone screen using the application to send a signal and subsequent command to the walker.

In one embodiment, the signal is transmitted from the smart phone to the walker-sensor, which may activate a control mechanism, such as to at least partially activate the brakes and/or stop the walker. This allows the movement of the walker to be controlled by the person operating the smart phone application. In one embodiment, the application may include a monitoring function which allows a parent or adult to observe the movement and/or play habits of the child remotely. Thus, the parent or adult may initiate a braking or moving command based on the playing habits of the child. For example, if the child is moving into a forbidden area the braking may be applied or if the child is moving into more appropriate or productive area, movement command may be applied.

It is to be understood that the above description is intended to be illustrative, and not restrictive. For example, the above-discussed embodiments may be used in combination with each other. Other embodiments not described explicitly are inherent and/or obvious to one of ordinary of skill in the art upon reviewing the above description.

The benefits and advantages which may be provided by the present disclosure have been described above with regard to specific embodiments. These benefits and advantages, and any elements or limitations that may cause them to occur or to become more pronounced are not to be construed as critical, required, or essential features of any or all of the embodiments.

While the present disclosure has been described with reference to particular embodiments, it should be understood that the embodiments are illustrative and that the scope of the disclosure is not limited to these embodiments. Many variations, modifications, additions and improvements to the embodiments described above are possible. It is contemplated that these variations, modifications, additions and improvements fall within the scope of the disclosure.

1. A method for remotely monitoring movements of a baby walker, the method comprising:
sensing an elevation of the baby walker in an area around the baby walker;
controlling the movement of the baby walker based on the sensed elevation.

2. The method according to claim 1, wherein controlling movement of the baby walker includes restricting the movement of the baby walker within an area.

3. A method for remotely monitoring movements of baby walker, the method comprising:
sensing position, speed, acceleration and surface characteristics of the baby walker in an area around the baby walker;
controlling the movement of baby walker based on at least one of the sensed position, speed, acceleration and the surface characteristics of the area baby walker is moving.

4. The method according to claim 3, wherein controlling further Includes comparing at least one of the sensed position, speed, acceleration or surface characteristics of the baby walker with a threshold value.

5. The method according to claim 3, wherein the position is determined using a OPS attached to the baby walker.

6. The method according to claim 4, wherein controlling include remotely controlling the baby walker via a smart device.

7. The method according to claim 4, wherein controlling includes stopping the movement of the baby walker when the baby walker approaches a boundary.

8. The method according to claim 4, wherein controlling include sending a warning signal to a smart device when the baby walker crosses a boundary.

9. A system for controlling a baby walker, the system comprising,
a plurality of sensors configured to sense data associated with the baby walker position and movement and communicate the sensed data to a remote device;
a controller including a memory and processor wherein the memory includes computer-executable instructions stored therein that, when executed by the processor, causes the processor to,
receive control instructions from the remote device; and
control the baby walker movement based on the received control signal.

10. The system for controlling fee baby walker according to claim 9, wherein the plurality of sensor's sense at least one of a position, speed, acceleration, and elevation of the baby walker.

11. The system for controlling the baby walker according to claim 10, wherein the control instructions include restricting the movement of the baby walker within an area.

12. The system for controlling the baby walker according to claim 10, wherein the control instructions include restricting the movement of the baby walker according to the elevation of the baby walker.

13. The system for controlling baby walker according to claim 10, wherein the control instructions include restricting the movement of the baby walker according to at least one of the sensed position, speed, acceleration and surface characteristics of the area the baby walker is moving.

14. The system for controlling baby walker according to claim 10, wherein the control instructions are generated by comparing at least one of the sensed position, speed, acceleration or surface characteristics of the area the baby walker is moving, with a threshold value.

15. The system for controlling the baby walker according to claim 10, wherein the plurality of sensor includes a GPS system.

16. The system for controlling the baby walker according to claim 10, wherein the remote device is a smart phone.

17. The system for controlling the baby walker according to claim 10, wherein the control signal is configured to stop the movement of the baby walker when the baby walker approaches a boundary.

18. The system for controlling the baby walker according to claim 10, wherein a warning signal is sent to the smart phone when the baby walker is about to cross a predetermined boundary.

19. The system for controlling the baby walker according to claim 16, wherein the remote device generates a visual guide using the sensed data, the visual guide prompting a direction or route to be used by a user.

20. The system for controlling the baby walker according to claim 19, wherein the visual guide is displayed on a touch sensitive interface of the remote device and is configured to generate the control signal in response to the user using the visual guide.
